(19) United States
(12) Patent Application Publication
(10) Pub. No.: US 2026/0180255 A1
(43) Pub. Date: Jun. 25, 2026

(54) SHIELDED PLUG CONNECTOR WITH SPRING SLEEVE

(71) Applicant: BELDEN DEUTSCHLAND GMBH, Schalksmühle (DE)

(72) Inventors: Peter KUHN, Köngen (DE); Volker MUTSCHLER, Pliezhausen (DE); Peter WEINMANN, Schlaitdorf (DE); Oliver TRAUTMANN, Köngen (DE); Matthias HESS, Großbettlingen (DE)

(73) Assignee: BELDEN DEUTSCHLAND GMBH, Schalksmühle (DE)

(21) Appl. No.: 19/128,775

(22) PCT Filed: Nov. 8, 2023
(86) PCT No.: PCT/EP2023/081171

§ 371 Date: May 9, 2025

(30) Foreign Application Priority Data
Nov. 11, 2022 (DE) 10 2022 129 953.8

(51) Int. Cl. H01R 13/6582; H01R 13/506; H01R 13/6592; H01R 13/6594; H01R 13/66

(52) U.S. Cl. CPC H01R 13/6582; H01R 13/506; H01R 13/6592; H01R 13/6594; H01R 13/6658

(57) ABSTRACT

A plug connector, arranged at one end of a shielded cable, wherein the plug connector has a housing made from a metal material, wherein this housing is electrically connected to a shielding of the shielded cable, for looping through the shielding starting from the cable via the plug connector, which can be plugged together with a correspondingly designed mating plug connector, wherein a spring sleeve is provided, which is pushed under the shielding of the cable and thereby brings the outer surface of the spring sleeve at least partially, in particular completely, into electrical contact with the shielding of the cable.

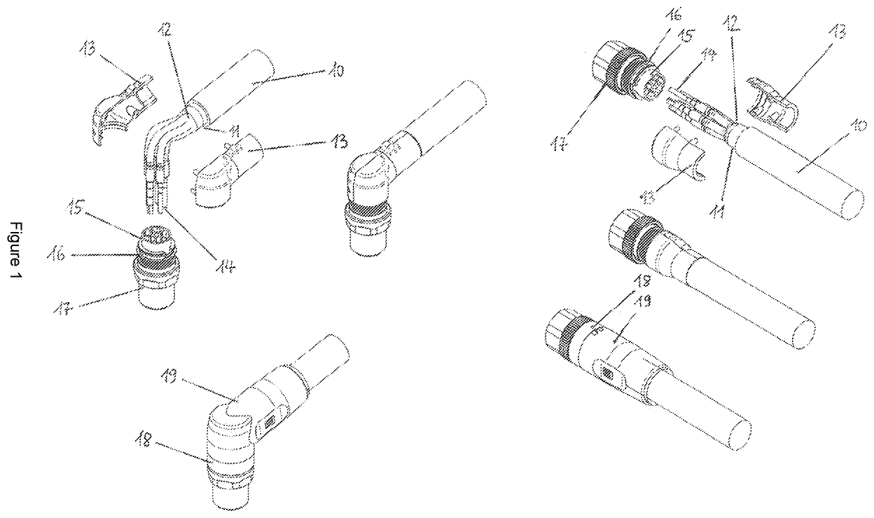

### DESCRIPTION

The invention relates to a shielded plug connector according to the features of the pre-characterizing portion of claim 1.

It is known that plug connectors are arranged at one end of a shielded cable, wherein the plug connector has a housing made from a metal material, wherein this housing is electrically connected to the shielding of the cable in order to loop through the shielding starting from the cable via the plug connector, which can be plugged together with a correspondingly designed mating plug connector.

Various arrangements are already known in the state of the art for making electrical contact between the cable and the housing of the plug connector. In one arrangement, a Pflitsch spring is placed over the outer surface of the exposed shielding of the cable, which is electrically contacted with the shielding of the cable in an internally concentric manner. Externally concentric, which is to say, with its outer surface, this Pflitsch spring abuts against the inner contour of the housing, configured, for example, in the form of a knurl nut.

The invention is based on the task of improving such a connection of the shielding of the cable to a metallic housing of the plug connector.

This task is solved by the features of claim 1.

According to the invention, a spring sleeve is provided which is pushed under the shielding, in particular under a braided shielding or under a shielding foil of the cable. This means that the outer surface of the spring sleeve is at least partially, in particular completely, electrically contacted with the shielding, preferably the braided shielding, of the cable. The inner contour of the spring sleeve abuts against a sheathing of at least one electrical conductor of the cable. If necessary, the sheathed conductor or several individual sheathed conductors can also be surrounded by a further sheath, which is accommodated inside the spring sleeve.

The spring sleeve forms a one-piece continuous component without recesses, slots or the like. In the simplest embodiment, the spring sleeve is thus a tubular, cylindrical structure, preferably with a round cross-section, wherein other cross-sections (for example, oval, square, rectangular and the like) may also be considered. The spring sleeve can, however, also additionally be provided with at least one recess and/or at least one slot in order to achieve a spring or clamping effect when the spring sleeve has been pushed under the shielding and thereby simultaneously over the at least one electrical conductor or its sheathing. If there is only one slot, this extends axially from one end to the other end of the spring sleeve, wherein the spring sleeve is slightly flared when it is pushed on.

After the spring sleeve has been arranged on the cable in the manner described above and contacted with the shielding of the cable (by abutment, or possibly alternatively or additionally by pressing on, electrical bonding, soldering, welding or the like), a shielding housing made from a metal material is arranged at least over the axial length of the spring sleeve, but possibly also beyond one or both of its end directions. The shielding housing can be configured in one piece, however preferably in two parts, in particular two identically shaped halves.

A further housing is arranged over the shielding housing, which further housing can form the outer housing of the plug connector. This outer housing, also made from a metal material, is electrically contacted to the shielding housing for looping through the shielding starting from the cable to a mating plug connector. The further housing can be configured as a screw connection, this means that it is rotatable in relation to the spring sleeve (but cannot be moved axially in relation to the spring sleeve or the cable) and can be screwed to a correspondingly designed mating plug connector after the plug connector and mating plug connector have been plugged together.

A contact carrier, preferably made from an electrically non-conductive material, is arranged inside the further housing, which contact carrier accommodates at least one contact of an electrical conductor of the cable, usually several contacts (if the cable comprises several electrical conductors).

After the further housing (screw connection) has been arranged, it can be considered to fill out the interior, in particular inside and around the contact carrier, with an electrically non-conductive material, in particular to overmold the inner cavities with such a material.

In one embodiment example, the overmolding is carried out in such a way that it encompasses an end part of the further housing (screw connection) as well as the spring sleeve up to an end area of the cable.

One such embodiment example is shown in the figure.

The left half of the figure shows an angled plug connector, whereas the right half of the figure shows a straight plug connector, both assembled and manufactured according to the invention.

In the right half of the figure, the finished straight plug connector is shown at the bottom right, wherein its individual parts and assembly steps can be seen in the two upper illustrations.

In the left half of the figure, the finished angled plug connector is shown at the bottom left, wherein its individual parts and assembly steps can be seen in the two upper illustrations.

The respective finished plug connector is arranged at the end of a cable 10. The cable 10 is a shielded cable, which under its outer sheath has a shielding 11, in particular a braided shielding, a shielding foil or the like. Underneath, at least one electrical conductor, usually several electrical conductors, are located inside the cable 10, each of which has its own outer sheathing. The cable 10 is, for example, a two-core or four-core twisted pair cable. According to the invention, a spring sleeve 12 is inserted between the outer sheathing of the at least one electrical conductor and the inner contour of the shielding 11. Alternatively, the spring sleeve 12 can also be pushed over the one electrical conductor or respectively over the plurality of electrical conductors and subsequently the shielding 11 is arranged over a partial area or over the entire axial extent of the spring sleeve 12. In any case, with the spring sleeve 12 according to the invention, the shielding 11, in particular the braided shielding, is prevented from being dissolved or needing to be deformed in the direction of the outer sheath of the cable 10, as this would impair the shielding properties. The shielding 11 is surrounded by a shielding housing 13, in the same manner as the end(s) of the electrical conductor, at the end of which in turn a contact 14 is respectively arranged. The respective contact 14 is arranged in a contact carrier 15 made from an electrically non-conductive material, in particular a plastic suitable for the intended use of the plug connector. A shielding sleeve 16 made from an electrically conductive material is arranged coaxially over the contact carrier 15 and, after its assembly, in operative connection with the shielding housing 13. Also arranged coaxially over a section of this shielding sleeve 16 is a screw connection 17, which is rotatably mounted relative to the fixed shielding sleeve 16. This screw connection 17 is used to plug and screw together the finished plug connector with a mating plug connector not shown in the figure, in order to prevent it from being unplugged.

The figure shows that the shielding housing 13 consists of two half shells. These two half shells are largely identical, except for pins on one half shell and corresponding depressions in the other half shell to accommodate the pins. The shielding housing 13 can also be formed in one piece or consist of more than two parts. It is arranged with its one end over the exposed area of the shielding 11, wherein an electrical contact is thereby also established between this shielding 11 and the shielding housing 13, which also consists of an electrically conductive material. The spring sleeve 12 inserted between the outer sheathing of the individual electrical conductors and the inner contour of the shielding 11 also serves to stabilize the abutment areas between the shielding 11 and shielding housing 13, so that effective electrical contact is achieved. The end of the contact 10 pointing towards the cable 10 is moved in the direction of the cable 10 so that the contacts 14 are inserted into the corresponding contact cavities of the contact carrier 15. In so doing, electrical contact is also made between one end of the shielding housing 13 and the other end of the shielding sleeve 16 facing it. The end of this assembly step can be seen in the right-hand illustration of the straight plug connector in the middle illustration. It is hereby ensured that the shielding 11 of the cable 10 is passed through all the way to the shielding sleeve 16 or alternatively the screw connection 17. This, moreover, ensures that the shielding 11 of the plug connector is looped through to the mating plug connector when these two have been plugged together. Which results in a continuous shielding thus being achieved.

In the lower right-hand representation of the right-hand half of the figure, it can also be seen that a pressing ring 18 has been arranged adjacent to the screw connection 17, pointing in the direction of the cable 10. This pressing ring 18 holds the two half shells of the shielding housing 13 together and brings about an installation of the screw connection 17 when it is rotated relative to the pressing ring 18. In addition, an overmolding 19 can, but does not necessarily need to, be provided over the contact carrier 15 and, above all, over the shielding housing 13, extending to the end area of the cable 10. Such an overmolding 19 protects the finished plug connector from external influences and can be manufactured very easily and very quickly. As an alternative to the overmolding 19, a separate outer housing can also be considered. This can, for example, once again consist of two half shells (identical or largely identical) or even of more than two parts.

The preceding description, which relates to the straight version of the plug connector according to the invention, also applies in a virtually analogous manner to the angled version of the plug connector according to the invention, which is shown in the left part of the figure. Based upon the angled design, in this case only the shielding housing 13 (or the two half shells forming the shielding housing 13) is configured differently and as shown. The screw connection 17 in the straight version of the plug connector, moreover, has knurling, whereas the screw connection 17 in the angled plug connector has sections that are angled towards each other. In this way, the screw connection 17 of the straight plug connector can be actuated by hand, whereas the screw connection 17 of the angled plug connector can be actuated with a tool. The reverse design or other designs are also conceivable for actuating the screw connection 17.

The principle according to the invention is described in more detail below in a few key words.
The braided shielding 11 of the cable is cut to the appropriate length, but not altered any further.
The spring sleeve 12 is pushed under the braided shielding 11 of the cable 10.

As a rule, in the state of the art, the braided shielding is brushed, which is to say, the braid is thus de-interlaced.

In most cases, they are even brushed back over the sheath and then once again brushed forwards in the subsequent production process.

Shielding housing 13, preferably in two parts, mounted on the outside of the braided shielding.

Shielding housing 13 with anti-rotation protection for contact carrier assembly 15/shielding sleeve 16.

Shielding housing 13 preferably not filled with plastic on the inside.

Shielding housing 13 with pins or alternatively holes, joined, for example by riveting. Other joining methods are possible.

Overmolding 19 of the assembly.

Arrangement of a pressing ring 18.

### List of Reference Signs

10. Cable
11. Shielding (in particular braided shielding)
12. Spring sleeve
13. Shielding housing
14. Contacts
15. Contact carrier
16. Shielding sleeve
17. Screw connection
18. Pressing ring
19. Overmolding

1. A plug connector which is arranged at one end of a shielded cable, wherein the plug connector has a housing made from a metal material, wherein this housing is electrically connected to a shielding of the shielded cable for looping through the shielding starting from the cable via the plug connector, which can be plugged together with a correspondingly designed mating plug connector, wherein a spring sleeve is provided, which is pushed under the shielding of the cable and thereby brings the outer surface of the spring sleeve at least partially, in particular completely, into electrical contact with the shielding of the cable.

2. The plug connector according to claim 1, wherein the spring sleeve forms a one-piece continuous component without recesses, slots or the like.

3. The plug connector according to claim 1, wherein the spring sleeve is provided with at least one recess and/or at least one slot.

4. The plug connector according to claim 1, wherein a shielding housing made from a metal material is arranged at least partially over the axial length of the spring sleeve, optionally beyond one or both of its end directions.

5. The plug connector according to claim 4, wherein the shielding housing is configured in one or two parts, in particular having two identically shaped halves or substantially identically shaped halves.

6. The plug connector according to claim 4, wherein a further housing, in particular a shielding, sleeve, is arranged over the shielding housing which further housing forms the outer housing of the plug connector, wherein the outer housing, made from a metal material, is electrically contacted to the shielding housing.

7. The plug connector according to claim 1, wherein the shielding is a braided shielding or a shielding foil.

8. The plug connector according to claim 6, wherein a contact carrier, preferably made from an electrically non-conductive material, is arranged inside the further housing, in particular inside the shielding sleeve, which contact carrier accommodates at least one contact of an electrical conductor of the cable.

9. The plug connector according to claim 6, wherein the interior of the further housing, in particular inside and around the contact carrier, is filled with an electrically non-conductive material.

10. The plug connector according to claim 4, wherein a pressing ring is arranged over the shielding housing.
